(19) United States
(12) Patent Application Publication
(10) Pub. No.: US 2024/0356257 A1
(43) Pub. Date: Oct. 24, 2024

(54) Self-Locking Connector Cover for a FFC/FPC Connector

(71) Applicants: TE Connectivity Solutions GmbH, Schaffhausen (CH); TE Connectivity Italia Distribution S.R.L., Torino (IT)

(72) Inventors: Claudia CEZZA, Torino (IT); Stefan Ernst GLASER, Bensheim (DE)

(73) Assignees: TE Connectivity Solutions GmbH, Schaffhausen (CH); TE Connectivity Italia Distribution S.R.L., Torino (IT)

(21) Appl. No.: 18/636,330

(22) Filed: Apr. 16, 2024

(30) Foreign Application Priority Data
Apr. 18, 2023 (IT) 102023000007560

(51) Int. Cl. H01R 12/77; H01R 4/02; H01R 13/506; H01R 43/18

(52) U.S. Cl. CPC H01R 12/774; H01R 4/023; H01R 13/506; H01R 43/18

(57) ABSTRACT

A connector cover (200) for a FFC/FPC connector (100) is described. The connector cover (200) for a FFC/FPC connector (100) comprises at least one electric terminals array (101), and it is slidable along a sliding direction (Z) from a fixed pre-lock position (PLP), in which at least one FFC/FPC (300) can be inserted into the cover connector (100) along an insertion direction (X), to a fixed lock-position (LP), in which the at least one FFC/FPC (300) is blocked into the connector (100) and can thus be welded to the at least one electric terminals array (101) of the connector (100). A connector device, a connector assembly, a connector kit and a method to form a connector assembly are described as well.

This application claims priority to and the benefit of Italian Patent Application No. 102023000007560 filed Apr. 18, 2023, which is hereby incorporated by reference in its entirety.

The present invention relates to the technical field of electrical connectors. In particular, the present invention refers to a connector cover for an electrical connector suitable to receive a flexible flat cable (FFC) or a flexible printed circuit (FPC).

### STATE OF THE ART

Electrical connectors suitable to receive FFC/FPC are commonly used, for example, in batteries for vehicles or similar devices.

These electrical connectors comprise a cover, that stays in an open position to allow the insertion of the FFC/FPC into the connector but that can also be brought to a lock position to fix the FFC/FPC in place for the welding of the FFC/FPC to the connector. Moreover, the trend for this kind of connectors is to have small dimensions, of the order of a few mm, better of the order of 5-10 mm, so as to fit also into small spaces.

One of the problems related to this kind of covers is to assure that the cover remains in an open position during transportation operations and while being handled during the assembly processes, avoiding an accidental and too-early closure before the FFC/FPC is in the right position to be welded to the connector. A further problem is to avoid an accidental and too-early closure, assuring at the same time the possibility to close the cover in a lock position, even when the connector has to be used in very small spaces.

In the state of the art related to this type of connectors movable covers are often employed. A movable cover is in a free open position, before the welding of the FFC/FPC to the connector and to allow the insertion of the FFC/FPC in the connector, and can be pivotally rotated to a closed position before the welding procedure. The problem of these covers is that accidental and too-early closure of same are not avoidable.

In some cases, the cover is in a fixed pre-lock position, before the welding of the FFC/FPC to the connector and to allow the insertion of the FFC/FPC in the connector and can be pivotally rotated to a lock position before the welding procedure. The problem of these covers is that in order to pivotally rotate the cover form the pre-lock position to the lock-position it is necessary to operate laterally on the connector, therefore the use of same into small spaces is not guaranteed.

Documents showing connectors with covers pivotally rotatable to a lock position according to the prior art are: EP 0926778 A2 and US 2002/0081883 A1.

### SUMMARY

The present invention relates to a connector cover for a FFC/FPC connector comprising at least one electric terminals array, wherein the cover is slidable along a sliding direction from a fixed pre-lock position, in which at least one FFC/FPC can be inserted into the cover connector along an insertion direction, to a fixed lock-position, in which the at least one

FFC/FPC is blocked into the connector and can thus be welded to the at least one electric terminals array of the connector.

In this way, an accidental and too early closure of the connector device can be efficiently avoided, even for very small connectors that needs to be mounted in small spaces. Moreover, a possible accidental and too early closure of the connector device is avoided without adding components to the connector device and assuring, in this way, the possibility to not increase the dimensions of same. Finally, since the cover is slidable from a pre-lock position to a lock position the use of the connector in small spaces can be also easily guaranteed.

According to a preferred embodiment, the cover comprises a main body and cover pins protruding from the main body, wherein the cover pins extend along the sliding direction. The cover pins can advantageously be configured to engage the cover in the pre-lock position and in the lock-position.

According to a further preferred embodiment, the cover pins comprise protruding hooks suitable to engage into the connector so as to fix the connector cover in the pre-lock position or in the lock-position. In particular, the hooks may be configured to alternatively fix the connector cover in the pre-lock position or in the lock-position.

According to a further preferred embodiment, the cover pins are elastically movable from an engaged position to an unengaged position. This is particularly advantageous because the movement of the pins is automatically controlled by exploiting the elasticity of same. In particular, the elastic force may tend to keep the cover pins in the engaged position. The user may act on the pins to disengage same, thus acting against the elastic force. Once the action of the user is stopped, the pins may automatically return into the engaged position by the action of the elastic force.

According to a further preferred embodiment, the main body comprises through-holes for reaching the cover pins so as to move the cover pins from an engaged position to an unengaged position. This allows further reducing the dimensions of the system. In particular, since the pins are reachable via through holes provided in the main body, there is no need to access the system from the sides, so that the lateral encumbrance of the system can be reduced.

According to a further preferred embodiment, the body further comprises welding holes, through which the at least one FFC/FPC can be welded to the at least one electric terminals array of the FFC/FPC connector. This allows optimizing the size of the system because no lateral access is needed to perform the welding operations.

According to a further preferred embodiment, the main body further comprises staple arms, extending into the sliding direction, to block the FFC/FPC so that it can be welded to the at least one electric terminals array of the connector, when the connector cover is in the lock position. In this way, the FFC/FPC is securely held into position during the welding operations.

The present invention further concerns a connector device comprising a FFC/FPC connector comprising at least one electric terminals array, and a connector cover according to any of the embodiments described above. Since the cover of the connector device is slidable along a sliding direction from a fixed pre-lock position to a fixed lock-position, the encumbrance of the device can be reduced.

According to a preferred embodiment, the connector comprises guiding holes suitable to receive the cover pins of the connector cover. The guiding holes may be configured to receive and guide the cover pins during sliding of the cover from the pre-lock position to the lock-position and vice versa.

According to a further preferred embodiment, the guiding holes further comprise a pre-lock recess, in which the protruding hook of the cover pin can engage when the connector cover is in the fixed pre-lock position and a locking recess, in which the protruding hook of the cover pin can engage when the connector cover is in the fixed lock position.

According to a particularly advantageous embodiment of the invention, the FFC/FPC connector is a double row connector and the connector device accordingly comprises a second connector cover according to any of the embodiments described above. In particular, the connector device accordingly comprises two covers according to the present invention. The two covers are advantageously slidable along one and the same direction or along parallel directions. Nevertheless, in order to bring the two covers from the pre-lock position to the lock position and vice-versa, it may be necessary to slide the two covers along opposite ways.

According to a particularly advantageous embodiment, the two covers of the double row connector are identical. To have identical covers is, in fact, economically advantageous. The position of the cover pins and their protruding hooks can be designed to this purpose. Nevertheless, this is not mandatory and the two covers may be different.

The present invention further concerns a connector assembly comprising a connector device according to any of the embodiments described above and at least one FFC/FPC welded to the at least one electric terminals array of the FFC/FPC connector. The connector assembly according to the invention may advantageously be implemented into a battery for a vehicle or the like.

The present invention further concerns a connector kit comprising a connector device according to any of the embodiments described above and a locking tool suitable to allow the sliding of the cover along a sliding direction from the fixed pre-lock position to the fixed lockposition. The locking tool is advantageously configured to operate with the cover to bring the cover from the fixed pre-lock position to the fixed lock-position and, preferably, vice versa as well.

According to a further preferred embodiment, the locking tool comprises a locking tool main body and locking tool pins, wherein the locking tool pins are configured to allow the elastic movement of the cover pins from the engaged position to the unengaged position and/or vice versa. For example, the locking pins may be configured to allow the protruding hooks of the cover to slide from the pre-lock recess of the connector to the locking recess of the connector and/or vice versa.

The locking tool further comprises a pressing tool configured to push the connector cover so as to slide it along a sliding direction to the fixed lock-position. The pressing tool also presses the connector cover against the connector, so to have a zero gap state, when the FFC/FPC is welded to the corresponding electric terminals array.

The present invention further concerns a method to form a connector assembly comprising the following steps: providing a connector device according to any of the embodiments described above with the connector cover fixed in the pre-lock position; inserting a FFC/FPC into the connector so that it is in the right electrical contact position to be welded to the electric terminals of the connector; sliding the cover from the pre-lock position to the lock position, so as to block the FFC/FPC in the right electrical contact position to be welded to the electric terminals of the connector. The method may further comprise the step of welding the FFC/FPC.

### BRIEF DESCRIPTION OF THE FIGURES

The present invention will be described with reference to the attached figures in which the same reference numerals and/or signs indicate the same part and/or similar and/or corresponding parts of the machine.

FIG. 1A schematically shows a 3D view of a connector device according to an embodiment of the present invention comprising a double row FFC/FPC connector with two connector covers fixed in a pre-lock position;

FIG. 1B schematically shows a 3D view of a connector assembly comprising the connector device shown in FIG. 1A and a FFC/FPC inserted in the double row FFC/FPC connector;

FIG. 1C schematically shows the connector assembly shown in FIG. 1B with the corresponding connector cover fixed in a lock position;

FIG. 1D schematically shows the connector assembly shown in FIG. 1C with two FFC/FPC inserted in the double row FFC/FPC connector and the two connector covers fixed in the lock position;

FIG. 2 schematically shows a 3D view of a connector cover according to an embodiment of the present invention;

FIG. 3A schematically shows a lateral view of a connector device according to an embodiment of the present invention;

FIG. 3B shows an enlarged particular of FIG. 3A;

FIG. 3C shows an upper view of the connector device shown in FIG. 3A;

FIG. 4 schematically shows a 3D view of a connector kit according to an embodiment of the present invention;

FIG. 5A to FIG. 5C schematically show an enlarged particular of the connector kit shown in FIG. 4 according to an embodiment of the present invention. More in particular the figures show the steps leading the connector cover to slide from the fixed pre-lock position to the fixed lock position.

### DETAILED DESCRIPTION OF THE FIGURES

In the following, the present invention is described with reference to particular embodiments as shown in the enclosed drawings. Nevertheless, the present invention is not limited to the particular embodiments described in the following detailed description and shown in the figures, but, instead, the embodiments described simply exemplify several aspects of the present invention, the scope of which is defined by the appended claims.

Further modifications and variations of the present invention will be clear for the person skilled in the art. Therefore, the present description has to be considered as including all the modifications and/or variations of the present invention, the scope of which is defined by the appended claims.

For simplicity, identical or corresponding components are indicated in the figures with the same reference numbers.

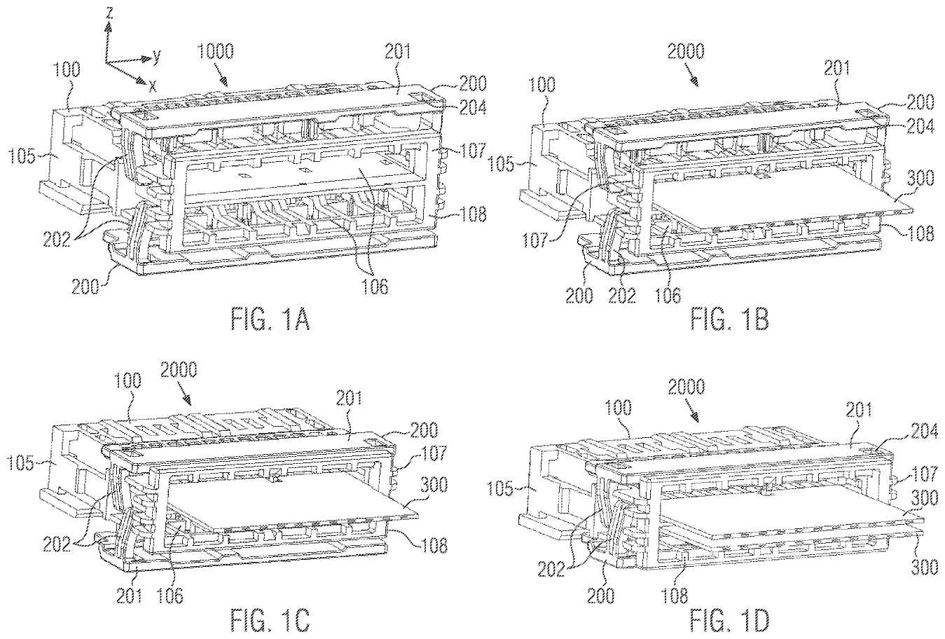

FIG. 1A shows a 3D view of a connector device 1000 according to an embodiment of the present invention comprising a double row FFC/FPC connector 100 with two connector covers 200 fixed in a pre-lock position PLP.

A FFC/FPC connector 100 according to the present invention is suitable to host at least one FFC/FPC 300 and comprises, therefore, at least one electric terminals array 101, suitable to put the FFC/FPC connector 100 in electrical contact with a corresponding FFC/FPC 300. The electric terminals array 101 is made of an electrical conductive material, for example a metallic material. The FFC/FPC 300 preferably comprises conductors trails, for example made of copper and/or aluminum. The FFC/FPC connector 100 comprises at least an insertion aperture 106, through which the FFC/FPC 300 can be inserted in the FFC/FPC connector 100.

The cover 200, applied on a FFC/FPC connector 100, according to the present invention, is slidable along a sliding direction Z (vertical in the figure) from a fixed pre-lock position PLP to a fixed lock position LP. In the fixed pre-lock position of the cover, a FFC/FPC 300 can be inserted into the FFC/FPC connector 100 along an insertion direction X. Moreover, if the cover is kept in this pre-lock position, the FFC/FPC 300 can also be removed from the connector. In the fixed lock position LP of the cover, the FFC/FPC 300 is blocked into the connector and can accordingly be welded to the electric terminals array 101 of the FFC/FPC connector 100.

Accordingly, with reference to the enclosed figures, Y is defined as the direction perpendicular both to the sliding direction Z and the insertion direction X and is referred to as connector plane direction. In this way a Cartesian reference system XYZ is defined, which will be conveniently used, in the following, to further describe the present invention.

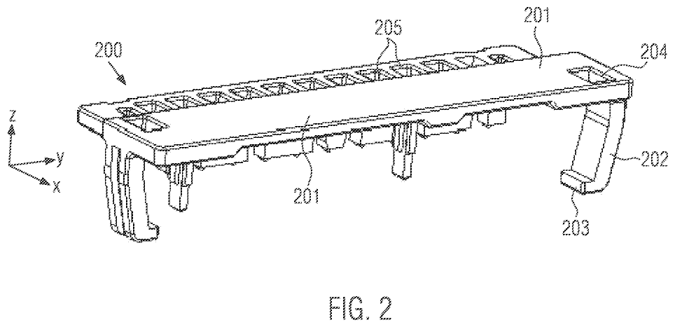

The FFC/FPC connector 100 comprises guiding holes 102 parallel to the sliding direction Z, a pre-lock recess 103 and a lock recess 104, whose use will be better explained when describing more in detail the connector cover 200 shown in FIG. 2.

The FFC/FPC connector 100 has a length along the connector plane direction Y, in function of the number of terminals in the electric terminals array 101, for example of the order of 22 mm. According to a preferred embodiment the number of terminals can be, for example, 10. The FFC/FPC connector 100 has a length along the insertion direction X, for example, of the order of 14.5 mm. The FFC/FPC connector 100 has a length along the sliding direction Z, for example, of the order of 6.7 mm.

The FFC/FPC connector 100 shown in FIG. 1A is a so called double row FFC/FPC connector 100. A double row FFC/FPC connector 100 practically consists of two FFC/FPC connectors, that are referred to as the upper connector half 107 and the lower connector half 108 of the double row FFC/FPC connector 100. The upper connector half 107 and the lower connector half 108 are united into one single housing and are superposed along the sliding direction Z so that one of the two FFC/FPC connectors is rotated of 180° around the insertion direction X. Each of the two FFC/FPC connector halves of the double row connector 100 is suitable to host one FFC/FPC 300. The two FFC/FPC connector halves are superposed so that two FFC/FPC can be inserted parallel to the XY plane. The double row FFC/FPC connector 100 comprises, in fact, two insertion apertures 106 and two electric terminals array 101, one for each FFC/FPC connector half forming the double row connector 100 and each of which is suitable to put into electrical contact the double row FFC/FPC connector 100 with a corresponding FFC/FPC 300. Each FFC/FPC connector half comprises guiding holes 102 parallel to the sliding direction Z, and further comprise a pre-lock recess 103 and a lock recess 104, whose use will be better explained when describing more in detail the connector cover 200 shown in FIG. 2.

The two connector covers 200 are slidable along the sliding direction Z from a fixed pre-lock position PLP, in which the two FFC/FPC 300 can respectively be inserted into the FFC/FPC connector 100 along an insertion direction X, to a fixed lock position LP, in which the two FFC/FPC 300 are blocked into the connector and can thus be welded to the corresponding electric terminals array 101 of each connector half forming the double row FFC/FPC connector 100. The two connector covers 200, in FIG. 1A are both shown in a fixed pre-lock position PLP.

FIG. 1B shows a 3D view of a connector assembly 2000 comprising the connector device 1000 shown in FIG. 1A and a FFC/FPC inserted in the double row FFC/FPC connector 100.

More in particular, FIG. 1B shows a double row FFC/FPC connector 100, with a FFC/FPC 300 inserted, parallel to the XY plane, into the insertion apertures 106 of the upper connector half 107 of the double row FFC/FPC connector 100 and with both the connector covers 200 in a fixed pre-lock position PLP.

FIG. 1C shows the connector assembly 2000 shown in FIG. 1B with the corresponding connector cover 200 fixed in a lock position LP. In this configuration, the FFC/FPC 300 is blocked in the connector and cannot be removed.

More in particular, FIG. 1C shows a double row FFC/FPC connector 100, with a FFC/FPC 300 inserted into the insertion aperture 106 of the upper connector half 107 and with the corresponding connector cover 200 in a fixed lock position LP. The other connector cover 200 is in a fixed pre-lock position PLP.

FIG. 1D shows the connector assembly 2000 shown in FIG. 1C with two FFC/FPC 300 inserted in the double row FFC/FPC connector 100 and the two connector covers 200 fixed in the lock position LP.

More in particular, FIG. 1D shows the double row FFC/FPC connector 100, with two FFC/FPC 300 inserted, respectively, into the insertion apertures 106 of both the upper connector half 107 and the lower connector half 108 and with both the corresponding connector covers 200 in the fixed lock position LP.

FIG. 2 shows a 3D view of a connector cover 200 according to the present invention. The connector cover 200 is slidable along a sliding direction Z (vertical, in the figure) from a fixed pre-lock position PLP, to a fixed lock position LP. In the pre-lock position PLP of the cover at least one FFC/FPC 300 can be inserted into the FFC/FPC connector 100 through the insertion aperture 106, along an insertion direction X. In the lock position LP of the cover the FFC/FPC 300 is blocked in the connector and can be welded to the electric terminals array 101 of the connector 100.

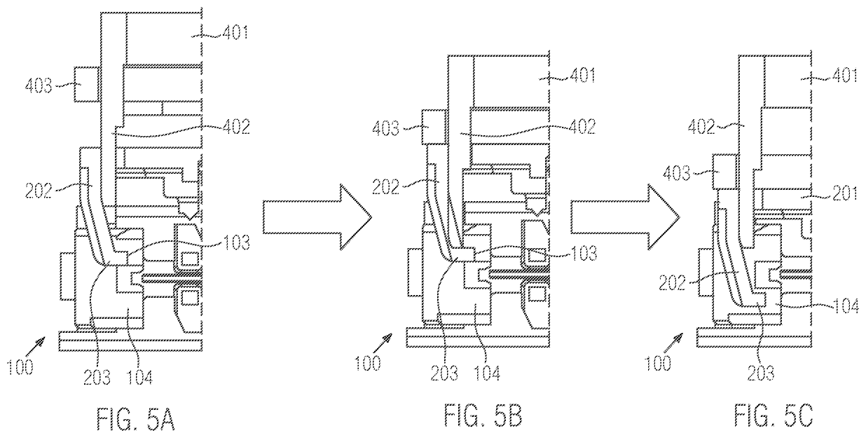

The connector cover 200 comprises a main body 201 and cover pins 202 protruding from the main body 201. The cover pins 202 extend along the sliding direction Z. The main body 201 extends parallel to the XY plane. Moreover, the cover pins 202 comprise protruding hooks 203 suitable to engage into the connector 100, so as to fix the connector cover 200 in the pre-lock position PLP or in the lock position LP. More in particular, the cover pins 202 can be inserted into the guiding holes 102 of the FFC/FPC connector 100 parallel to the sliding direction Z, and are elastically movable from an engaged position to an unengaged position. More specifically, the protruding hooks 203 have a profile so as to properly engage in the pre-lock recess 103 or in the lock recess 104 of the FFC/FPC connector 100, when the cover pins 202 are in an engaged position. This is better visible in FIGS. 5A-5C showing in detail how the cover pins 202 slide inside the guiding holes 102 and how the protruding hooks 203 can engage in the pre-lock recess 103 or in the lock recess 104.

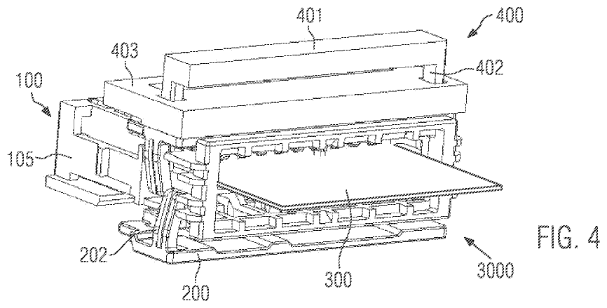

The main body 201 of the connector cover 200 further comprises through-holes 204 for reaching the cover pins 202, for example by means of a locking tool 400, as schematically shown in FIG. 4, so as to move the protruding hooks 203 from the engaged position into the pre-lock recess 103 to an unengaged position, to slide along the sliding direction Z, and to finally engage again in an engaged position into the lock recess 104.

The main body 201 further comprises welding holes 205, through which the FFC/FPC 300, properly inserted into the insertion aperture 106 of the FFC/FPC connector 100, can be welded to the electric terminals array 101 of the FFC/FPC connector 100.

The main body 201 further comprises staple arms 206, extending along the sliding direction Z and suitable to block the FFC/FPC 300 in position, so that it can be welded to the electric terminals array 101 of the connector 100, when the connector cover 200 is in the lock position LP.

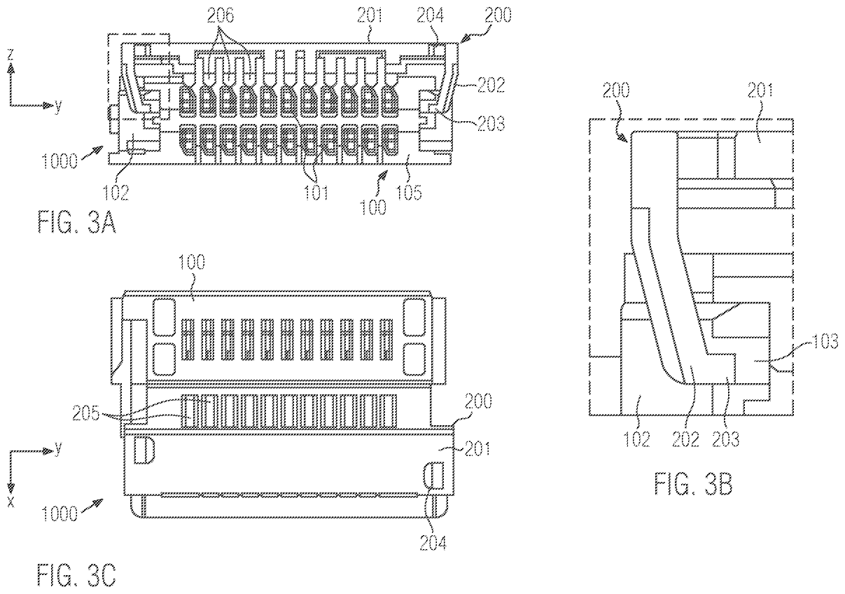

FIG. 3A shows a lateral view of a connector device 1000 according to an embodiment of the present invention.

More in particular, FIG. 3A shows the connector device 1000 seen along the insertion direction X, i.e. parallel to the YZ plane, so as to show the insertion aperture 106 of the connector 100, into which the FFC/FPC 300 can be inserted into the FFC/FPC connector 100. The electric terminals array 101 is visible as well.

The connector cover 200 comprises a cover main body 201 and cover pins 202. The cover pins 202 are inserted inside the guiding hole 102 of the FFC/FPC connector 100.

Each cover pin 202 ends with a protruding hook 203 which abuts toward the FFC/FPC connector 100, along the connector plane direction Y. The guiding hole 102 of the FFC/FPC connector 200 comprises a pre-lock recess 103 inside which the protruding hook 203 can engage. When the protruding hook 203 is inserted inside the pre-lock recess 103, the cover 200 is in the fixed pre-lock position PLP, from which it cannot accidentally move, excluding the possibility of an accidental and/or too early closure of the connector device. In fact, the connector cover 200 can slide to the fixed locked position LP only using a specific locking tool 400, as will be explained describing FIGS. 5A to 5C. If no locking tool 400 is used, the connector cover 200 remains, therefore, fixed in the pre-lock position, for example during transportation operations and/or while being handled during the assembly processes, before the FFC/FPC 300 is in the right position to be welded to the FFC/FPC connector 100.

FIG. 3B shows an enlarged particular of FIG. 3A.

The figure shows the cover pins 202 inserted into the guiding hole 102, with the protruding hook 203 engaged in the pre-lock recess 103. The connector cover 200 is accordingly fixed in the pre-lock position PLP.

FIG. 3C shows an upper view of the connector device 1000 shown in FIG. 3A.

This figure shows the connector device 1000 from above. In particular, the cover main body 201, the through-holes 204 and the welding holes 205 of the connector cover 200 are visible.

FIG. 4 shows a 3D view of a connector kit 3000 according to an embodiment of the present invention.

More in particular FIG. 4 shows the connector assembly 2000 shown in FIG. 1, with the locking tool 400 applied on it. The locking tool 400 is suitable to allow the sliding of the cover 200 along the sliding direction Z from the fixed pre-lock position PLP, to the fixed lock position LP, as will be better explained describing FIG. 5A to 5C. As shown in the figure, the locking tool 400 comprises a locking tool main body 401 and locking tool pins 402. The locking tool pins 402 are suitable to be inserted into the through holes 204 of the connector cover 200, so as to reach the cover pins 202 and assuring the elastic movement of the cover pins 202 from an engaged position to an unengaged position, as described better with reference to FIGS. 5A to 5C. The locking tool 400 further comprises a pressing tool 403 suitable to push the connector cover 200 so as to slide it along the sliding direction Z, for example from the fixed pre-lock position PLP to the fixed lock-position LP. The pressing tool 403 comprises holes for the insertion of the locking tool pins 402, in correspondence of the through holes 204 of the connector cover 200.

FIG. 5A to FIG. 5C show an enlarged particular of the connector kit 3000 shown in FIG. 4 according to an embodiment of the present invention.

More in particular the figures from 5A to 5C show the steps leading the connector cover 200 to slide from the fixed pre-lock position PLP to the fixed lock position LP.

FIG. 5A shows the locking tool 400 initially inserted through the through hole 204 of the connector cover 200. In particular, the locking tool pin 402 of the locking tool 400 is partially inserted into the through hole 204 of the cover. The tool main body 401 is in touch with the pressing tool 403. Both the tool main body 401 and the pressing tool 403 are not in touch with the cover main body 201. The cover pin 202 is inserted in the guiding hole 102 and is in the fixed pre-lock position PLP, i.e. it is in an engaged position, because the protruding hook 203 is engaged in the pre-lock recess 103 of the FFC/FPC connector 100. When the cover pin 202 is in such a position, the connector cover 200 is fixed in the pre-lock position PLP.

FIG. 5B shows the locking tool 400 further inserted into the through hole 204 of the connector cover 200. The locking tool 400 has been pushed inside the guiding hole 102 of the FFC/FPC connector 100, so that the tool main body 401 and the pressing tool 403 are now in touch with the cover main body 201. The vertical movement of the locking tool pin 402 has forced the cover pin 202 to be elastically released from the fixed pre-lock position PLP, so as to be in an unengaged position. The protruding hook 203 is, in fact, no more engaged in the pre-lock recess 103 of the FFC/FPC connector 100. When the cover pin 202 is forced by the locking pin 402 of the locking tool 400 in such a position, the connector cover 200 is free to slide along the sliding direction Z, pushed by the pressing tool 403.

Finally, FIG. 5C shows the locking tool main body 401 pulled out from the through hole 204 of the connector cover 200 and the connector cover 200 positioned in the lock position LP. The tool main body 401 is no more in touch with the pressing tool 403. The pressing tool 403 is still in touch with the cover main body 201 and has pushed it along the sliding direction so that the cover pin 202 is more deeply inserted in the guiding hole 102 and the protruding hooks 203 is now at the same height of the lock recess 104. Since the locking tool 400 does no longer force the cover pin 202 in an unengaged position, the cover pin 202 elastically moves back into the fixed lock position PLP, i.e. it is in an engaged position, because the protruding hook 203 is engaged in the lock recess 104 of the FFC/FPC connector 100. When the cover pin 202 is in such a position, the connector cover 200 is fixed in the lock position PLP. The pressing tool 403 further comprises holes for allowing the welding of the FFC/FPC onto the electric terminals array 101, in correspondence of the welding holes 205 of the connector cover 200. The welding of the FFC/FPC onto the electric terminals array 101 can, therefore, be performed in this position. After the welding operations also the pressing tool 403 can be moved away from the connector assembly 2000.

In the following, a method to form a connector assembly 2000 according to the present invention is disclosed. The method comprises the following steps: providing a connector group 1000 according to the present invention with the cover 200 fixed in the pre-lock position PLP; inserting a FFC/FPC 300 into the connector 100 so that it is in the right electrical contact position to be welded to the electric terminals array 101 of the connector 100; sliding the cover 200 from the pre-lock position PLP to the lock position LP, so as to block the FFC/FPC 300 in the right electrical contact position to be welded to the electric terminals array 101 of the connector 100.

The method further comprises the step of using the locking tool 400 to elastically move the cover pins 202 from an engaged position to an unengaged position.

Finally the method further comprises the step of using the locking tool 400 to allow the sliding of the protruding hooks 203 of the cover pins 202 from the pre-lock position PLP to the lock position LP.

Even though the present invention has been described with reference to the embodiments described above, it is clear to those skilled in the art that it is possible to make different modifications of the present invention in light of the teaching described above and in the appended claims, without departing from the scope of protection of the invention.

For example, even if a double row FFC/FPC connector has been shown in detail, the present invention is not limited to double row connectors, but comprises also single row connectors, i.e. connectors with a single cover according to the present invention. Moreover, even if the two covers of the double row connector have been shown as being identical, the present invention is not limited thereto and comprises also configurations of the double row connector with two different covers, for example with two covers according to different embodiments of the present invention, or with a cover according to an embodiment of the present invention and a cover not according to the present invention.

Moreover, the number of terminals of the electric terminals array and, consequently, the dimensions of the FFC/FPC connector can vary according to needs and are not limited to the examples described above.

Finally, those aspects that are considered known by those skilled in the art have not been described in order to avoid needlessly excessively obscuring the description of the invention.

Consequently, the invention is not limited to the embodiments described above, but is only limited by the scope of protection of the appended claims.

### REFERENCE NUMBERS

100 FFC/FPC connector
101 electric terminals array
102 guiding hole
103 pre-lock recess
104 lock recess
105 connector main body
106 insertion aperture
107 upper connector half of a double row FFC/FPC connector
108 lower connector half of a double row FFC/FPC connector
200 connector cover
201 cover main body
202 cover pin
203 protruding hook
204 through-hole
205 welding hole
206 staple arms
300 FFC/FPC
400 locking tool
401 locking tool main body
402 locking tool pin
403 pressing tool
1000 connector device
2000 connector assembly
3000 connector kit
PLP pre-lock position
LP lock position
x insertion direction
Y connector plane direction
Z sliding direction

1. A connector cover for a flexible flat cable or a flexible printed circuit (FFC/FPC) connector comprising at least one electric terminals array, said cover is slidable along a sliding direction from a fixed pre-lock position, in which at least one FFC/FPC can be inserted into said FFC/FPC connector along an insertion direction, to a fixed lock-position, in which said at least one FFC/FPC is blocked into said connector.

2. The connector cover according to claim 1, wherein said connector cover comprises a main body and cover pins protruding from said main body, wherein said cover pins extend along said sliding direction.

3. The connector cover according to claim 2, wherein said cover pins comprise protruding hooks suitable to engage into said connector so as to fix said connector cover in said pre-lock position or in said lock-position.

4. The connector cover according to claim 2, wherein said cover pins are elastically movable from an engaged position to an unengaged position.

5. The connector cover according to claim 2, wherein said main body comprises throughholes for reaching said cover pins so as to move said cover pins from an engaged position to an unengaged position.

6. The connector cover according to claim 1, wherein said main body further comprises welding holes, through which said at least one FFC/FPC can be welded to said at least one electric terminals array of said FFC/FPC connector.

7. The connector cover according to claim 1, wherein said main body further comprises staple arms, extending into the sliding direction, to block the FFC/FPC so that it can be welded to said at least one electric terminals array of said connector, when the connector cover is in the lock position.

8. A connector device comprising a FFC/FPC connector comprising at least one electric terminals array), and a connector cover according to claim 1.

9. The connector device according to claim 8, wherein said FFC/FPC connector comprises guiding holes suitable to receive cover pins protruding from a main body of said connector cover, the cover pins protruding from said main body, wherein said cover pins extend along said sliding direction

10. The connector device according to claim 9, wherein said guiding holes further comprise a pre-lock recess, in which said protruding hook of said cover pin can engage when said connector cover is in said fixed pre-lock position, and a locking recess, in which said protruding hook of said cover pin can engage when said connector cover is in said fixed lock position.

11. The connector device according to claim 8, wherein said FFC/FPC connector is a double row connector and said connector device comprises a second connector cover according to claim 1.

12. The connector device according to claim 11, wherein the two connector covers are identical.

13. A connector assembly comprising a connector device according to claim 8 and at least one FFC/FPC welded to said at least one electric terminals array of said FFC/FPC connector.

14. A connector kit comprising a connector device according to claim 8 and a locking tool suitable to allow the sliding of said cover along a sliding direction from said fixed pre-lock position to said fixed lock-position.

15. The connector kit according to claim 14, wherein said locking tool comprises a locking tool main body and locking tool pins, wherein said locking tool pins are configured to allow the elastic movement of said cover pins from said engaged position to said unengaged position.

16. The connector kit according to claim 15, wherein said locking pins are configured to allow said protruding hooks of said cover to slide from said pre-lock recess of said connector to said locking recess of said connector.

17. The connector kit according to claim 14, wherein said locking tool further comprises a pressing tool suitable to push said connector cover so as to slide said connector cover along a sliding direction to said fixed lock-position.

18. A method to form a connector assembly comprising the following steps:
providing a connector device according to claim 8 with the connector cover fixed in the pre-lock position;
inserting a FFC/FPC into the connector so that it is in the right electrical contact position to be welded to the electric terminals of the connector;
sliding the cover from the pre-lock position to the lock position, so as to block the FFC/FPC in the right electrical contact position to be welded to the electric terminals of the connector.

19. The method according to claim 18, wherein sliding the cover from the pre-lock position to the lock position is carried out by means of a locking tool.

20. The method according to claim 19, wherein said locking tool is used to elastically move cover pins of said connector cover from an engaged position to an unengaged position.
